(19) United States
(12) Patent Application Publication
(10) Pub. No.: US 2026/0011261 A1
(43) Pub. Date: Jan. 8, 2026

(54) Systems and Methods for Automated Scoring of Constructed Responses

(71) Applicant: Educational Testing Service, Princeton, NJ (US)

(72) Inventors: Vladimir Zubenko, Princeton, NJ (US); Jodi M. Casabianca-Marshall, Princeton, NJ (US); Gary Feng, Princeton, NJ (US)

(21) Appl. No.: 19/262,895

(22) Filed: Jul. 8, 2025

Related U.S. Application Data
(60) Provisional application No. 63/668,534, filed on Jul. 8, 2024.

(51) Int. Cl. G09B 7/02

(52) U.S. Cl. CPC G09B 7/02

(57) ABSTRACT

A computer-implemented method for generating a score for a constructed response is described. A constructed response is received. A plurality of scores is generated for the constructed response using a plurality of automated scoring models of different types that are configured to evaluate the constructed response and provide a corresponding numerical score. The plurality of scores is input into a trained aggregation model configured to compute a composite score based on the plurality of scores. A score for the constructed response is generated based on the composite score.

### CROSS-REFERENCE TO RELATED APPLICATIONS

This application claims priority to U.S. Provisional Application No. 63/668,534, filed Jul. 8, 2024, entitled “Synthetic Scoring of Constructive Responses by Human Raters and Multiple AI Scoring Systems,” which is incorporated herein by reference in its entirety.

### TECHNICAL FIELD

The present application relates to systems and methods for automated scoring of constructed responses, and more particularly to systems and methods that combine outputs from multiple models to produce scores with improved accuracy and reliability.

### BACKGROUND

Written responses, such as those used in educational settings, are valuable tools for assessing learning and providing feedback that can help individuals improve. These responses are typically scored by trained human graders, such as teachers, by using a rubric that defines how different aspects of the response should be evaluated. While human scoring is considered reliable, it is also time consuming, costly, and can be inconsistent across different responses or different graders.

Therefore, there is a need for automated scoring methods that can provide accurate, reliable, and efficient evaluation of written responses.

### SUMMARY

A computer-implemented method for generating a score for a constructed response is described. A constructed response is received. A plurality of scores is generated for the constructed response using a plurality of automated scoring models of different types that are configured to evaluate the constructed response and provide a corresponding numerical score. The plurality of scores is input into a trained aggregation model configured to compute a composite score based on the plurality of scores. A score for the constructed response is generated based on the composite score.

Training the aggregation model comprises accessing a training dataset comprising a plurality of constructed responses, wherein each constructed response is associated with a true score and a plurality of scores generated by the plurality of automated scoring models. Initial weights are assigned to each automated scoring model based on a comparison of the score generated by the automated scoring model with the true score. A composite score is generated for each constructed response based on the plurality of scores generated by the automated scoring models and the weights assigned to each automated scoring model. The composite score is compared to the true score to calculate a performance metric. The weights assigned to each automated scoring model are iteratively adjusted to improve the performance metric.

### DESCRIPTION OF DRAWINGS

FIG. 1 illustrates an example scoring engine 100 that is configured to provide a score for a constructed response.

FIG. 2 illustrates further details of an example embodiment of the scoring engine that includes an aggregation model.

FIG. 3 illustrates an example training process for the aggregation model.

FIG. 4 illustrates another embodiment of the scoring engine 100 that incorporates both automated scoring models and human raters.

FIG. 5 illustrates an example process flow diagram for scoring a constructed response.

FIG. 6 illustrates an example process flow diagram for training an exemplary aggregation model.

FIGS. 7A-7C depict example systems for implementing the approaches described herein for automated scoring of constructed responses.

### DETAILED DESCRIPTION

Certain example systems and methods described herein relate to scoring of constructed responses using a combination of automated scoring models, including Large Language Models (“LLMs”) and traditional Natural Language Processing (“NLP”) engines. This approach is configured to improve the validity and reliability of scoring responses in education and assessment contexts by combining the strengths of multiple, independent scoring models.

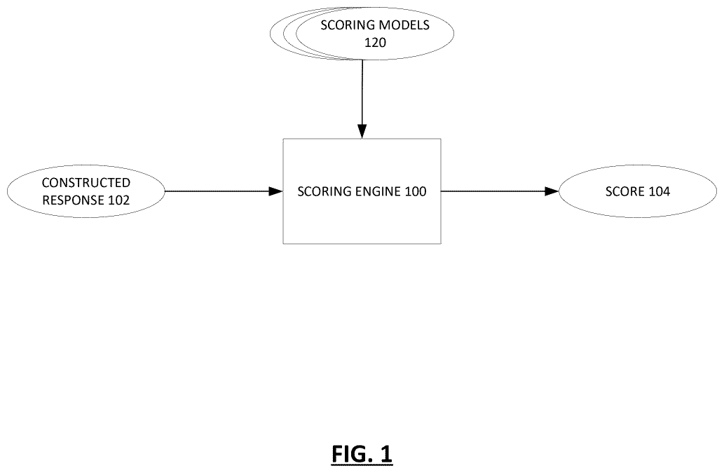

FIG. 1 illustrates an example scoring engine 100 that is configured to receive a constructed response 102 as input, and provide a score 104 for the response. A constructed response refers to an answer in response to a prompt that is provided by a learner or a test taker. For example, the constructed response 102 may be in the form of a written essay, a short answer, a summary of a passage, or a transcription of a spoken response or an audio file containing a spoken response. These responses typically arise in educational and testing contexts where writing, speaking, or analysis skills are being evaluated.

In addition to the constructed response 102, the scoring engine 100 also utilizes a plurality of scoring models 120. Scoring models 120 may comprise various types of artificial intelligence models that are configured to assess and evaluate written text. For example, traditional NLP-based models may be used that extract linguistic or structural features to evaluate the input, or LLMs may be used that can be prompted to generate scores for the input, or multimodal LLMs may be used that are capable of scoring responses relating to both text and visual prompts.

In embodiments, a scoring model may be configured to evaluate the constructed response 102 according to its own architecture and scoring guidelines. In embodiments, a scoring model may be prompted along with a scoring rubric to score the constructed response 102 as well as provide an explanation for the score. The NLP-based scoring models may be trained using supervised learning where a large volume of human scored responses are provided to train the model. The LLM-based scoring models may be built with either no human scoring data (e.g., zero-shot prompt engineering) or with much less human scoring data (e.g. few-shot prompt engineering or fine tuning). Additionally, some scoring models may be fine tuned to specific subject matters such as history or literature.

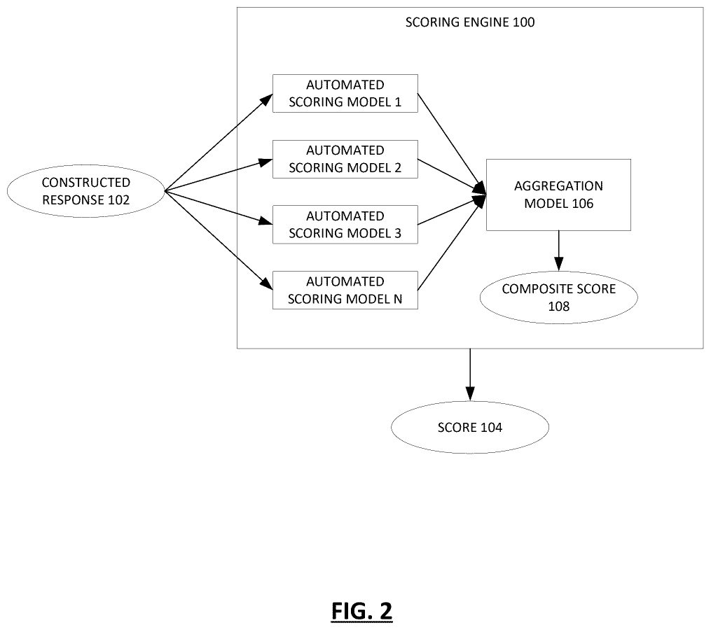

Each scoring model 120 is configured to assess the constructed response 102 such that the constructed response 102 has a plurality of scores associated with it. The scoring engine 100 is configured to compute a singular score 104 for the constructed response 102 based on the plurality of scores generated by the scoring models 120. This process is explained in detail with respect to FIG. 2 below.

The configuration embodied in FIG. 1 allows the scoring engine 100 to leverage multiple scoring models, each with different strengths and capabilities, so that the overall evaluation is valid and reliable. For example, some scoring models may be sensitive to grammar and structure, while others may be specific to a particular subject matter. By combining their evaluation, the scoring engine 100 may avoid the limitations of any single model, such as bias or blind spots, by leveraging complementary strengths from other models, which results in a robust evaluation.

FIG. 2 illustrates further details of an example embodiment of the scoring engine 100 that includes an aggregation model 106. The constructed response 102 is provided as input to a set of automated scoring models, shown here as models 1 through N. Each model may vary in type and configuration. For example, automated scoring model 1 may be a traditional feature-based NLP engine that is configured to assess grammar, mechanics, or organization, while automated scoring model 2 may be an LLM that can be prompted to apply a rubric and generate a numerical score accordingly. Some models may also be specifically fine tuned on the particular topic that is the subject of the constructed response 102. A variety of models may be used so different aspects of the constructive response 102 are holistically assessed.

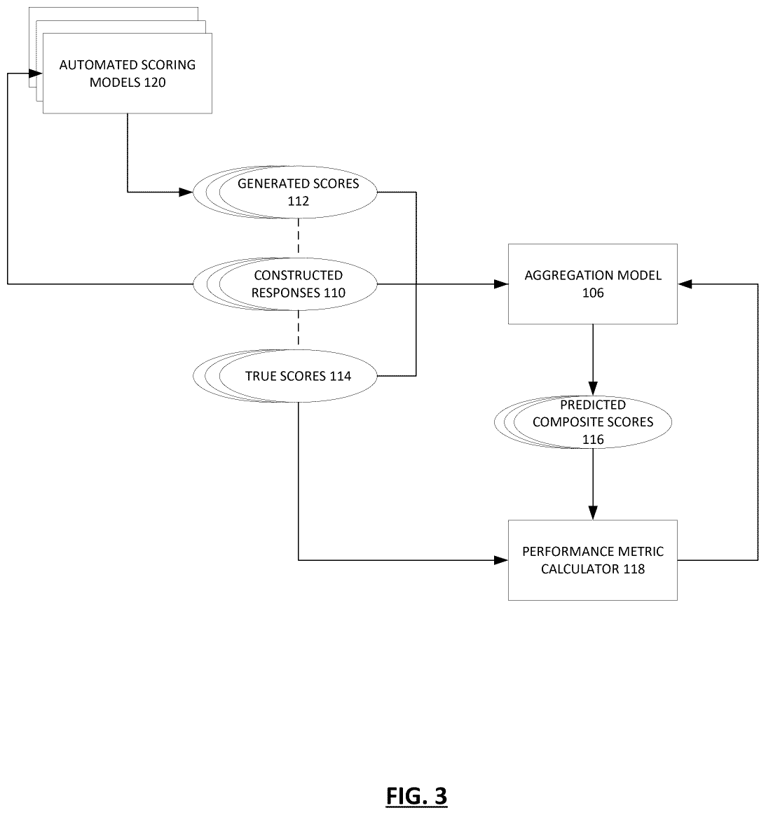

Each model is configured to generate a numerical score for the same constructed response 102. These scores are provided to the aggregation model 106, which is configured to compute a composite score 108 for the constructed response 102 based on the plurality of scores that it receives. The aggregation model 106 may be implemented as a regression model that assigns different weights to each input score based on how well each score aligns with a benchmark. As will be explained in more detail below with respect to FIG. 3, the aggregation model 106 is trained using historical data so that it can learn the optimal weight distribution for each scoring model. This configuration allows the aggregation model 106 to output a composite score 108 that represents an optimized synthesis of the individual scores. In embodiments, the aggregation model 106 may be implemented as an algorithm or a machine-learning predictive model, such as a linear regression model, a decision tree, or a support vector machine.

In embodiments, a final score 104 is provided based on the composite score 108. For example, the composite score 108 may be a numerical score, but it may need to conform to the requirements of a given assessment, such as within a scale of 1 to 6, a 0 to 100 percentage, a letter grade, or some other standardized format. In embodiments, the scoring engine 100 may convert the composite score 108 to the score 104 to comply with any such requirements. The score 104 represents a final, holistic evaluation of the constructed response 102. The score 104 draws on the strengths of each scoring model to integrate diverse perspectives on the various aspects of the constructed response 102.

In some embodiments, each of the automated scoring models may be further configured to generate a textual rationale alongside the score that it assigns to the constructed response 102. These rationales may provide explanations as to why a particular score was given. For example, the explanation may reference various aspects of the constructed response 102 that contributed to the score such as grammar, content, accuracy, or responsiveness to the prompt. The automated scoring models may be configured to provide these explanations, or they may be prompted to do so.

In embodiments, the scoring engine 100 may use a separate LLM configured to process the individual explanations generated by each automated scoring model. The individual scores and explanations may be provided as input to the LLM, along with a prompt instructing it to generate a single, unified explanation for the composite score 108 that provides a coherent explanation combining the perspectives of the various scoring models. This configuration provides a richer feedback to the writer of the constructed response 102 with actionable insights into their numerical score.

FIG. 3 illustrates an example training process for the aggregation model 106. This training process enables the aggregation model 106 to learn how to combine the outputs of multiple automated scoring models to produce a composite score that is closely aligned with a benchmark.

The embodiment shown in FIG. 3 begins with a plurality of constructed responses 110. Each constructed response 110 is provided to a plurality of automated scoring models 120 that are configured to evaluate the response and generate a score for the response. The plurality of automated scoring models 120 thus outputs a plurality of generated scores 112 for each constructed response. In embodiments, the plurality of automated scoring models 120 comprise scoring models of different kinds as explained above. For example, one model may be specific to writing mechanics, whereas another may be subject matter-specific. As a result, each constructed response 110 has a corresponding array of generated scores 112 that each capture different kinds of evaluations.

Each constructed response 110 also has a corresponding true score 114. The true score 114 is configured as a benchmark or reference point against which the generated scores 112 are assessed. The true score 114 is computed based on multiple, independent human scores that are provided by trained human graders. In embodiments, the human graders may provide scores based on a standardized scoring rubric that is aligned with the prompt that the constructed response is responsive to. Use of a standardized prompt may result in consistency in scoring across multiple constructed responses as well as writers. The true score 114 is considered the most reliable assessment of the constructed response 110. It serves as the ground truth for training the aggregation model 106.

Each constructed response 110 is associated with a plurality of generated scores 112 and one true score 114. All three are input into the aggregation model 106, which is trained to combined the generated scores 112 in a manner that best approximates the true score 114. In embodiments, the aggregation model 106 may begin by assigning initial weights to each scoring model 120. The weights represent the degree of influence that each model's score will have on the final composite score. For example, a scoring model 120 that has a higher weight will have a greater influence on the final composite score than another model that has a lower weight.

In embodiments, the initial weights assigned to each scoring model 120 may be uniform. In other embodiments, the initial weights assigned to each scoring model 120 may be based on a comparison of the generated score 112 with the corresponding true score 114 for a particular constructed response 110. For example, in an embodiment where four scoring models 120 are use, one of the models may consistently generates scores that are closest to the true score 114 as compared to the scores generated by the other scoring models. That model would be assigned the highest weight. Conversely, another model may consistently deviate from the true score, so it would be assigned the lowest weight.

Once the initial weights are assigned to the automated scoring models 120 for a given constructed response 110, the aggregation model 106 computes a predicted composite score 116 for that response. The predicted composite score 116 represents the weighted combination of the generated scores 112, where each score's influence on the composite score depends on the initial weights assigned to the corresponding scoring models. In embodiments, the aggregation model 106 may be implemented as an algorithm or as a regression model.

The predicted composite scores 116 are provided to a performance metric calculator 118, which is configured to compare the predicted composite scores 116 against the true scores 114. This comparison yields a performance metric that quantifies the accuracy or agreement between the two scores. The performance metric calculator 118 may be implemented as a statistical measure such as percentage difference, quadratic weighted kappa, root mean square error, or proportional reduction in mean-squared error.

In embodiments, based on the performance metric, the aggregation model 106 is configured to enter an iterative feedback process in which the weights assigned to each automated scoring model 120 may be adjusted. This adjustment process may take into account multiple considerations to optimize the system. For example, how closely each individual scoring model aligns with the true score may be one consideration. Additionally, how the combination of models 120 collectively perform with respect to the weights assigned to each may be another consideration.

For example, if one scoring model 120 consistently generates scores that are very close to the true score 114, that model may be assigned a higher weight in the process to generating a composite score 116. Conversely, a model that consistently generates scores that deviates from the true score may have its weight reduced, or even removed completely.

In embodiments, the system may also be iteratively adjusted based on how different weight combinations impact the composite scores 116. For example, two models may individually show the same level of agreement with the true score 114, but when assigned similar weights, their prediction errors may amplify. Even though both models seems to perform similarly on their own, the aggregation model 106 may explore assigning different weights to each model, and comparing the predicted composite score 116 with the performance metric 118 to determine which weight distribution results in an overall better performance.

In embodiments, this fine-tuning process also supports dynamic model selection to determine which scoring models 120 are particularly suited to specific types of task. For example, in the context of scoring a Chemistry assignment, where the rubric places greater emphasis on accuracy rather than language quality, the aggregation model 106 may learn to assign more weight to models that are sensitive to content and less weight to models that prioritize writing mechanics. By contrast, in a narrative writing task, models that evaluate grammar, coherence, and organization may carry more weight. Through an iterative fine-tuning process, the aggregation model 106 can adaptively tailor the combination of scoring models 120 to best fit the type of task at hand.

In embodiments, this fine-tuning process may also address systemic scoring patterns or biases of individual scoring models 120. For example, the system may detect that a particular model 120 consistently undershoots the true score 114 by half a point. Rather than eliminating the model, the aggregation model 106 may adjust its weight to account for the bias. Similarly, another model may perform well overall, but its scoring on responses from non-native speakers may be inaccurate due to an overemphasis on grammar. Depending on the use case, the weight for that model may be similarly adjusted to reduce such bias.

Through iterations of feedback based on both comparison of individual model scores with the true score, as well as comparison of the composite score with the true score, the aggregation model 106 learns how to assign weights to individual models, as well as which model is best suited to a particular task. Each iteration may update the combination of scoring models 120 as well as the weights assigned to each to determine an optimal combination that aligns best with the scoring objectives for that particular context.

In embodiments utilizing LLMs, the iterative feedback process may also be utilized to assess and refine the prompts that are used to elicit scores from the automated scoring models 120. Because prompt quality affects the LLM output, the aggregation model 106 may help determine whether a particular prompt configuration leads to a reliable and accurate composite score 116 or not. For example, when using the same combination of scoring models 120, if one version of a prompt produces a poor performance metric as compared to another, the lower performing prompt may be flagged for review and the higher performing prompt may be marked for use.

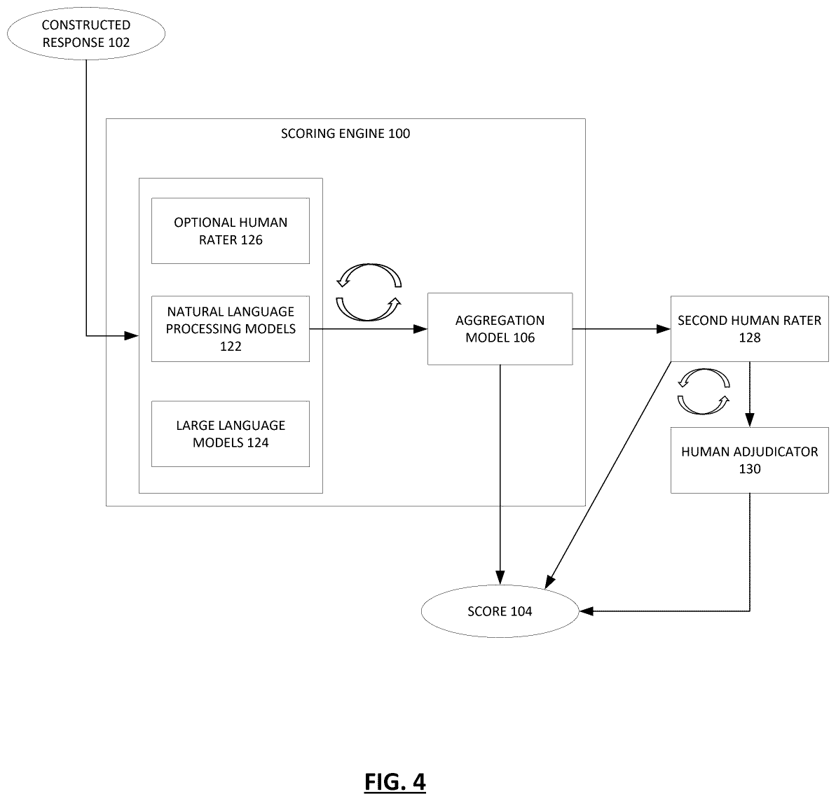

FIG. 4 illustrates another embodiment of the scoring engine 100 that incorporates both automated scoring models and human raters in a dynamic workflow. This embodiment introduces quality control checkpoints throughout that can intervene based on the level of agreement between different scores.

The scoring engine 100 receives a constructed response 102 for evaluation, and assesses it using a combination of models. It includes an n number of NLP models 122 and an n number of LLMs 124. In addition, the scoring engine 100 may also include an optional human rater 126. Each model 122 and 124, and the human rater 126 independently generate a score for the constructed response 102. The scores generated as then input into an aggregation model 106, which is configured to compute a composite score 104 using one of the methods explained above. I

In this embodiment, before the aggregation model 106 output a composite score, the system may perform a real-time assessment of whether the generated scores are in agreement. For example, the system may calculate a disagreement metric to quantify the degree of divergence between the scores generated by the human rater 126 and the models 122 and 124. The disagreement metric may be calculated based on a statistical model or algorithm. If the disagreement metric exceeds a predefined threshold, the constructure response 102 is flagged for additional human review by second human rater 128. This additional human review ensures additional scrutiny in cases of high disagreement before a final score is reported. The second human rater 128 may be more experienced or may have additional training than the initial optional human rater 126. The second human rater 128 may validate the composite score generated by the aggregation model 106, or may adjust the score based on an independent evaluation of the constructed response 102 in alignment with a rubric.

In embodiments, a third level of human review is utilized via human adjudicator 130. The human adjudicator 130 may represent a higher tier of scoring expertise as compared to the other two human raters. For example, the human adjudicator 130 may be an expert on the subject matter contained in the constructed response 102. In embodiments, the final score 104 from the aggregation model 106 may diverge from the score generated by the second human rater 128, which may trigger further review by the human adjudicator 130. In embodiments, the second human rater 128 may be unable to resolve the discrepancies between the scores, which may be an additional trigger for the human adjudicator 130.

The additional layers of human review utilized in this embodiment supports both accuracy and accountability in the final score 104. The final score 104 may be directly output from the aggregation model 106 when all scorers are in agreement. If there is a disagreement, the score may be adjusted by the second human rater 128. If there are further disagreements or issues that require specific expertise, the score may be further adjusted by the human adjudicator 130.

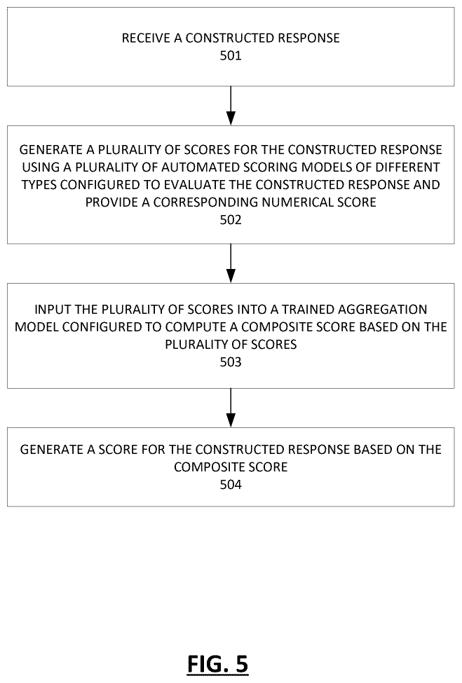

FIG. 5 illustrates an example process flow diagram for scoring a constructed response. At 501, a constructed response is received. At 502, a plurality of scores is generated for the constructed response using a plurality of automated scoring models of different types that are configured to evaluate the constructed response and provide a corresponding numerical score. At 503, the plurality of scores is input into a trained aggregation model configured to compute a composite score based on the plurality of scores. At 504, a score for the constructed response is generated based on the composite score.

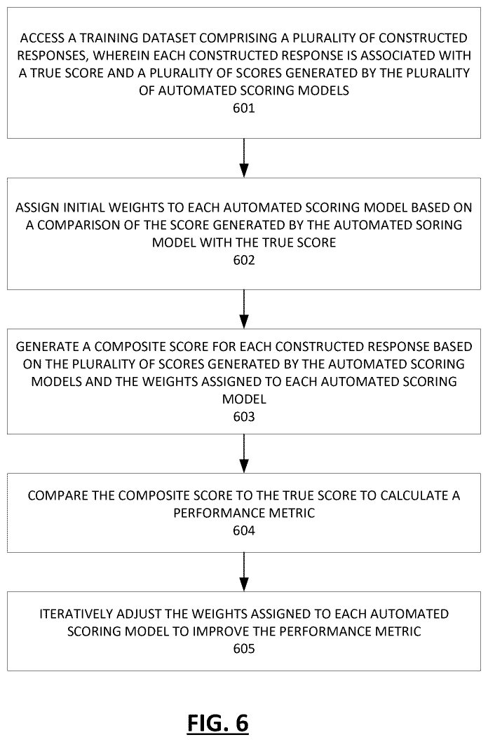

FIG. 6 illustrates an example process flow diagram for training an exemplary aggregation model. At 601, a training dataset is accessed comprising a plurality of constructed responses, wherein each constructed response is associated with a true score and a plurality of scores generated by the plurality of automated scoring models. At 602, initial weights are assigned to each automated scoring model based on a comparison of the score generated by the automated scoring model with the true score. At 603, a composite score is generated for each constructed response based on the plurality of scores generated by the automated scoring models and the weights assigned to each automated scoring model. At 604, the composite score is compared to the true score to calculate a performance metric. At 605, the weights assigned to each automated scoring model are iteratively adjusted to improve the performance metric.

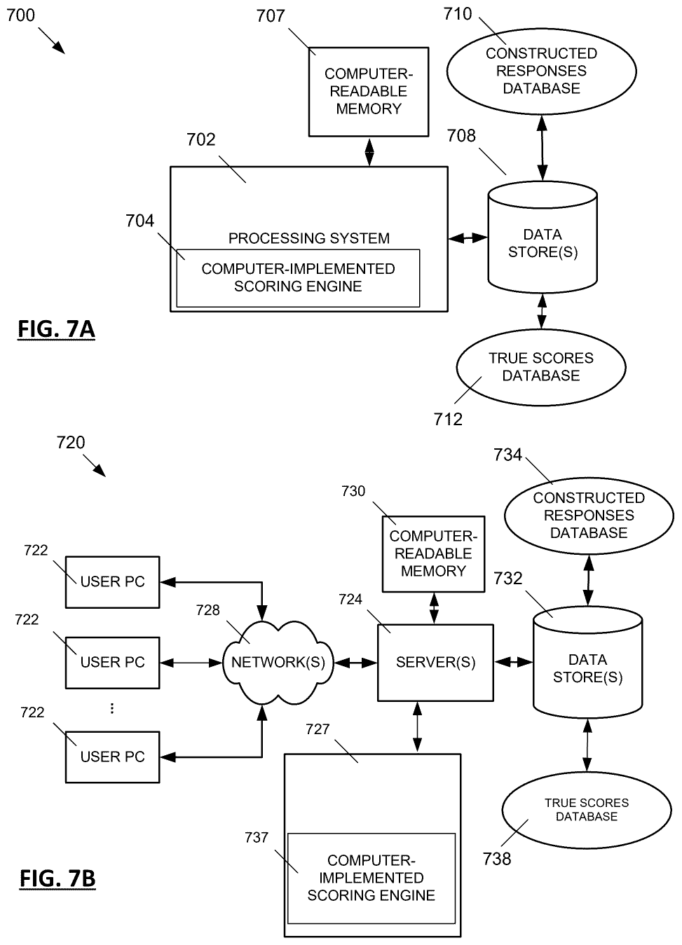

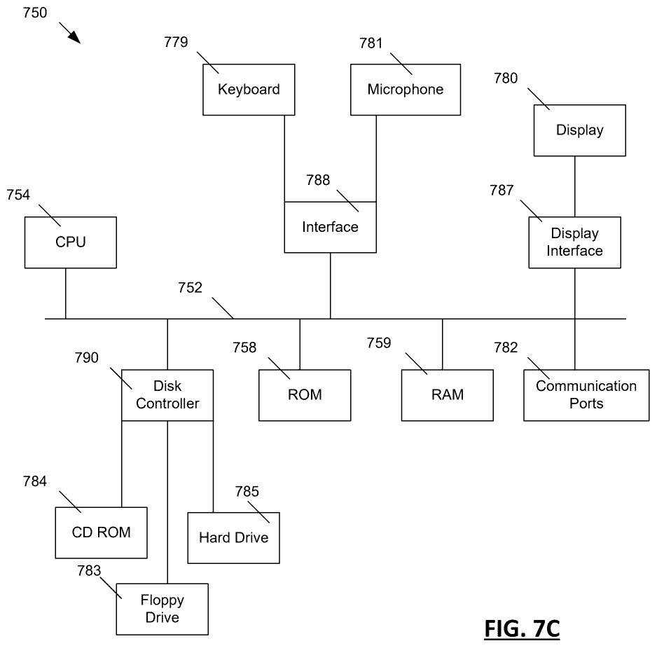

FIGS. 7A, 7B, and 7C depict example systems for implementing the approaches described herein for automated scoring of constructed responses. For example, FIG. 7A depicts an exemplary system 700 that includes a standalone computer architecture where a processing system 702 (e.g., one or more computer processors located in a given computer or in multiple computers that may be separate and distinct from one another) includes a computer-implemented scoring engine 704 being executed on the processing system 702. The processing system 702 has access to a computer-readable memory 707 in addition to one or more data stores 708. The one or more data stores 708 may include a constructed responses database 710 as well as a true scores database 712. The processing system 702 may be a distributed parallel computing environment, which may be used to handle very large-scale data sets.

FIG. 7B depicts a system 720 that includes a client-server architecture. One or more user PCs 722 access one or more servers 724 running a computer-implemented speech scoring model 737 on a processing system 727 via one or more networks 728. The one or more servers 724 may access a computer-readable memory 730 as well as one or more data stores 732. The one or more data stores 732 may include a constructed responses database 734 as well as a speech features database 938.

FIG. 7C shows a block diagram of exemplary hardware for a standalone computer architecture 750, such as the architecture depicted in FIG. 7A that may be used to include and/or implement the program instructions of system embodiments of the present disclosure. A bus 752 may serve as the information highway interconnecting the other illustrated components of the hardware. A processing system 754 labeled CPU (central processing unit) (e.g., one or more computer processors at a given computer or at multiple computers), may perform calculations and logic operations required to execute a program. A non-transitory processor-readable storage medium, such as read only memory (ROM) 758 and random access memory (RAM) 759, may be in communication with the processing system 754 and may include one or more programming instructions for performing the method of automated scoring of constructed responses. Optionally, program instructions may be stored on a non-transitory computer-readable storage medium such as a magnetic disk, optical disk, recordable memory device, flash memory, or other physical storage medium.

In FIGS. 7A, 7B, and 7C, computer readable memories 707, 730, 758, 759 or data stores 708, 732, 783, 784, 788 may include one or more data structures for storing and associating various data used in the example systems for automated scoring of constructed responses. For example, a data structure stored in any of the aforementioned locations may be used to store data from XML files, initial parameters, and/or data for other variables described herein. A disk controller 790 interfaces one or more optional disk drives to the system bus 752. These disk drives may be external or internal floppy disk drives such as 783, external or internal CD-ROM, CD-R, CD-RW or DVD drives such as 784, or external or internal hard drives 785. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 790, the ROM 758 and/or the RAM 759. The processor 754 may access one or more components as required.

A display interface 787 may permit information from the bus 752 to be displayed on a display 780 in audio, graphic, or alphanumeric format. Communication with external devices may optionally occur using various communication ports 782.

In addition to these computer-type components, the hardware may also include data input devices, such as a keyboard 779, or other input device 781, such as a microphone, remote control, pointer, mouse and/or joystick.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, for example, or any other suitable programming language. Other implementations may also be used, however, such as firmware or even appropriately designed hardware configured to carry out the methods and systems described herein.

The systems' and methods' data (e.g., data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

1. A computer-implemented method for generating a score for a constructed response, comprising:
receiving a constructed response;
generating a plurality of scores for the constructed response using a plurality of automated scoring models of different types configured to evaluate the constructed response and provide a corresponding numerical score;
inputting the plurality of scores into a trained aggregation model configured to compute a composite score based on the plurality of scores; and
generating a score for the constructed response based on the composite score.

2. The method of claim 1, wherein training the aggregation model comprises:
accessing a training dataset comprising a plurality of constructed responses, wherein each constructed response is associated with a true score and a plurality of scores generated by the plurality of automated scoring models;
assigning initial weights to each automated scoring model based on a comparison of the score generated by the automated scoring model with the true score;
generating a composite score for each constructed response based on the plurality of scores generated by the automated scoring models and the weights assigned to each automated scoring model;
comparing the composite score to the true score to calculate a performance metric; and
iteratively adjusting the weights assigned to each automated scoring model to improve the performance metric.

3. The method of claim 1, wherein the constructed response comprises a textual response to a prompt.

4. The method of claim 1, wherein the automated scoring models comprise at least one Natural Language Processing model and at least one Large Language Model.

5. The method of claim 4, wherein the automated scoring models further comprise at least one multimodal scoring model configured to evaluate a constructed response that is associated with an image or a video.

6. The method of claim 1, further comprising comparing the plurality of scores provided by the plurality of automated scoring models of different types to each other to determine a disagreement metric, wherein a human scoring process is triggered if the disagreement metric exceeds a predefined threshold.

7. The method of claim 1, wherein the plurality of scores includes a human generated score for the constructed response.

8. The method of claim 2, wherein the aggregation model comprises a regression model.

9. The method of claim 8, wherein the regression model comprises a linear regression model, a decision tree, or a support vector machine.

10. The method of claim 3, wherein the true score is calculated based on multiple human generated scores for the constructed response, wherein the human generated scores are provided by trained human raters using a scoring rubric that aligns with the prompt.

11. The method of claim 2, wherein the performance metric comprises a statistical measure of accuracy or agreement between the composite score and the true score.

12. The method of claim 11, wherein the performance metric comprises one or more of percentage difference, quadratic weighted kappa, mean squared error, and percent reduction in mean squared error.

13. The method of claim 2, wherein adjusting the weights assigned to each of the automated scoring models comprises increasing the weights assigned to the automated scoring models whose scores are closer to the true score relative to the other automated scoring models.

14. The method of claim 13, further comprising decreasing the weights assigned to the automated scoring models whose scores are farther from the true score relative to the other automated scoring models.

15. The method of claim 14, further comprising assigning a weight of zero to one or more automated scoring models whose scores are farthest from the true score to exclude those automated scoring models from contributing to the composite score.

16. The method of claim 2, wherein each of the plurality of automated scoring models is further configured to generate a textual explanation associated with the score it generates for the constructed response.

17. The method of claim 16, further comprising using a Large Language Model configured to process the plurality of explanations to generate a unified explanation associated with the composite score for the constructed response.

18. The method of claim 2, further comprising selecting a subset of the plurality of automated scoring models based on the comparison of the scores generated by the automated scoring models with the true scores and the performance metric.

19. A system comprising:
one or more data processors; and
a computer-readable medium encoded with instructions for commanding the one or more data processors to execute steps of a process, the steps comprising:
receiving a constructed response;
generating a plurality of scores for the constructed response using a plurality of automated scoring models of different types configured to evaluate the constructed response and provide a corresponding numerical score;
inputting the plurality of scores into a trained aggregation model configured to compute a composite score based on the plurality of scores; and
generating a score for the constructed response based on the composite score.

20. The system of claim 19, wherein training the aggregation model comprises:
accessing a training dataset comprising a plurality of constructed responses, wherein each constructed response is associated with a true score and a plurality of scores generated by the plurality of automated scoring models;
assigning initial weights to each automated scoring model based on a comparison of the score generated by the automated scoring model with the true score;
generating a composite score for each constructed response based on the plurality of scores generated by the automated scoring models and the weights assigned to each automated scoring model;
comparing the composite score to the true score to calculate a performance metric; and
iteratively adjusting the weights assigned to each automated scoring model to improve the performance metric.
